(19) United States
(12) Patent Application Publication
(10) Pub. No.: US 2013/0002333 A1
(43) Pub. Date: Jan. 3, 2013

(54) Receiver side combining in LINC Amplifier

(76) Inventors: Saqib Ali, Islamabad (PK); Bamidele Adebisi, Manchester (GB); Garik Markarian, Lancaster (GB)

(21) Appl. No.: 13/172,659

(22) Filed: Jun. 29, 2011

(51) Int. Cl. G06G 7/12

(52) U.S. Cl. 327/355

(57) ABSTRACT

A new method of combing signals of equal magnitude using the space-time (ST) 2×1 code at the receiver in a linear amplification with nonlinear components (LINC) is provided to obviate the combiner power loss and isolation requirements inherent in using traditional methods.

### FIELD OF THE INVENTION

This invention refers generally to the field of linear amplification with nonlinear components (LINC) amplifiers and the use of space-time coding to combine signals.

### BACKGROUND

In order to address the insatiable demand for high data-rate, various wireless broadband standards have adopted bandwidth efficient modulation schemes such as OFDM at physical layer [1, 2]. One of the drawbacks of such a multicarrier scheme is that they suffer from the high peak to average power ratio problem. This means that the peaks are quite far from the average power. The problem associated with such a modulation scheme is that it requires a linear amplification. If this is not done then it results in the BER degradation, reduction in efficiency and the out of band spectral emissions. Linear amplifier is an expensive solution. One of the ways to circumvent this is to use nonlinear amplifiers with a modified signal, which has a constant envelope. It is well known that constant envelope signal can be amplified using a non-linear device [3]. In this amplification process, a varying envelope signal is split into two constant envelope signals. These components are then amplified individually using nonlinear amplifiers. The outputs of the two amplifiers are subsequently combined to generate a composite amplified signal. This method is called as linear amplification using nonlinear components shortly referred as LINC in literature [4-8]. The main challenge with this technique is the combining of the two amplified signals as there are several difficulties in the use of the combiners in LINC amplifiers such as to design a linear combiner while maintaining high isolation between the two amplifiers output [9]. A significant unmet need therefore exists in the field of instant invention.

### BRIEF DESCRIPTION OF DRAWINGS

FIG. 1: A split approach for nonlinearity mitigation

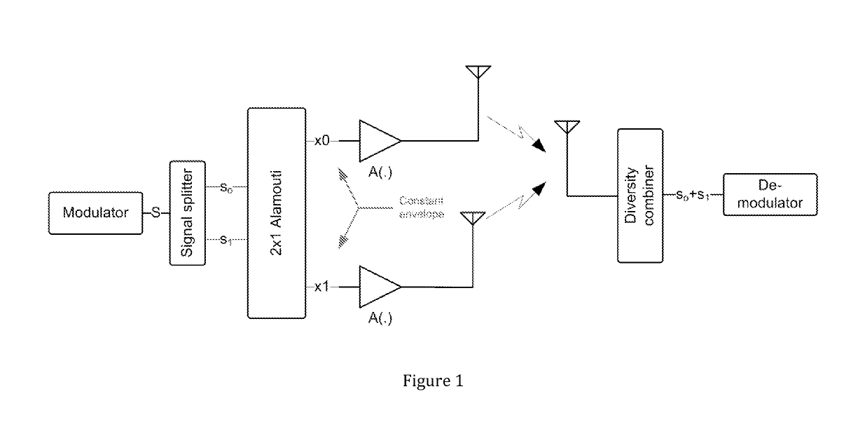

FIG. 2: Splitting of the vector into two constant magnitude vectors

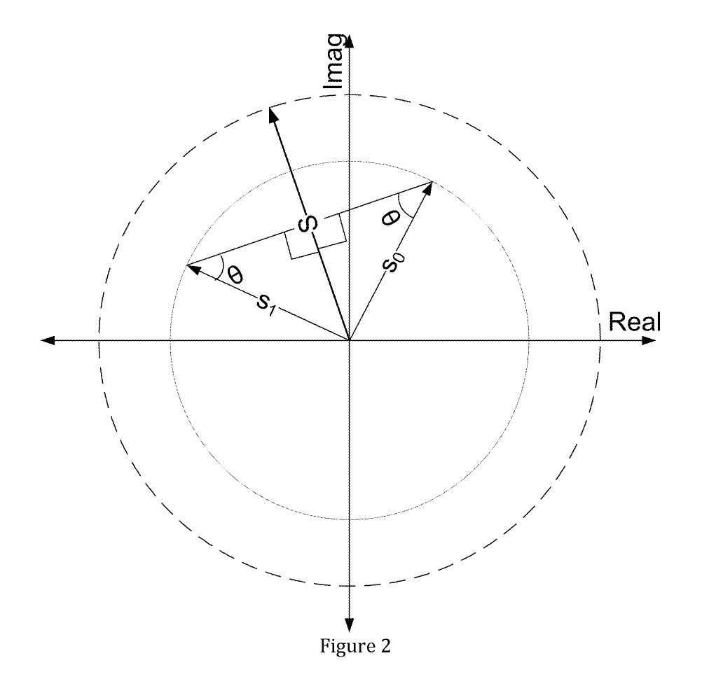

FIG. 3: Splitting of the vector into two constant magnitude vectors

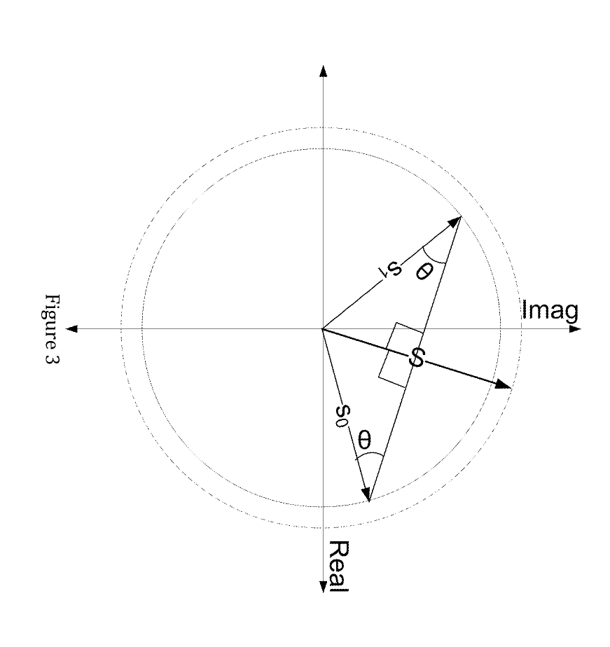

### DETAILED DESCRIPTION OF THE INVENTION

To circumvent the aforementioned problem, Abdelaal [10] introduced the concept of combining these high power signals on air, such that the receiver receives the combination of the two signals of LINC. He presented the design and simulation of 2×1 LINC amplifiers using two antennas at the transmitter. The two transmit antennas are placed close enough such that the channels for each of them is assumed to be the same. Thus at the receiving antenna, a sum of the signal is received. This technique provides very good isolation, however there is a constraint of placing the antennas very close to each other. Therefore practical implementation of such a technique is limited to applications where closely spaced antennas can be arranged and tolerated.

The instant invention uses a 2×1 Almaouti Space Time Block Codes (STBC) in an LINC based amplification method. This scheme is used to use the diversity combiner at the receiver to reconstruct the transmitted signal. This is a time-multiplexed technique that can relax the antenna placement constraints [7]. The spacing can be as much as permitted in the MIMO techniques, however in this technique the channel is considered known at the receiver.

Moreover, the channel for the two symbol intervals is considered to be unchanged [11]. The complete setup is presented in Error! Reference source not found.

If S is a complex varying envelope baseband signal, represented as given in Eq. (1)

S=a(t) (1)

where a(t) is a complex valued signal. Then the passband signal Sₚₐₛₛ can be represented as

Sₚₐₛₛ=a(t)e^{jω}^{_{c}}^{t} (2)

The real part is amplified and transmitted, thus the signal provided as input into the amplifier becomes as following

Sₐₘₚ=Re{a(t)e^{jω}^{_{c}}^{t}} (3)

The symbol S can be split into two complex constant magnitude symbols s₀ and s₁, such that it the sum of the two is equal to the original.

S=s₀−s₁ (4)

In Error! Reference source not found. and Error! Reference source not found., two different scenarios for the splitting of the input vectors are shown.

It can be seen from the two figures that although the magnitude of the input signal is changing, the magnitude of the two split components remain the same. These are the two components are then given to the two nonlinear amplifiers of the LINC.

If V₀ is the magnitude of the split components, and θ(t) be the angle as shown in Error! Reference source not found. and Error! Reference source not found., then θ(t) is given as

$$\begin{matrix}θ ( t ) = {sin}^{- 1} ( \frac{S}{{s}_{1}} ) \\ = {sin}^{- 1} ( \frac{a ( t )}{2 {V}_{o}} )\end{matrix} \qquad ( 5 )$$

So the vector S becomes

S=2V₀[sin(θ(t))]i (6)

Thus from trigonometric identity, the two equi-magnitude baseband complex signals become as following in Eq. (7)

s₀=V₀[cos(θ(t))+i sin(θ(t))]

s₁=V₀[−cos(θ(t))+i sin (θ(t))] (7)

Their equivalent conjugates are as following in Eq. (8)

s*₀=V₀[cos(θ(t))−i sin(θ(t))]

s*₁=V₀[−cos(θ(t))−i sin(θ(t))] (8)

By applying Alamouti code s₀ and s₁ can be transmit and the signal at the receiver becomes as in Eq. (9)

r₀=h₀s₀+h₁s₁+n₀

r₁=−h₀s*₁+h₁s*₀+n₁ (9)

where h₀ and h₁ are the complex gains for the channels. And n₀ and n₁ are the noise in the channels. The estimate of the symbols at the receiver can be obtained using the following diversity combining as in Eq. (10)

$$\begin{matrix}{s}_{o} \% = {h}_{o}^{*} {r}_{o} + {h}_{1} {r}_{1}^{*} \\ {s}_{1} \% = {h}_{1}^{*} {r}_{o} - {h}_{o} {r}_{1}^{*} & ( 10 ) \\ \begin{matrix}{s}_{o} \% = {{h}_{o} ( {h}_{o} {s}_{o} + {h}_{1} {s}_{1} + {n}_{o} )}^{*} + {h}_{1}^{*} ( - {h}_{o} {s}_{1}^{*} + {h}_{1} {s}_{o}^{*} + {n}_{1} ) \\ = ( {\vert {h}_{o} \vert}^{2} + {\vert {h}_{1} \vert}^{2} ) {s}_{o} + {h}_{o} {n}_{o}^{*} + {h}_{1}^{*} {n}_{1}\end{matrix} & ( 11 ) \\ \begin{matrix}{s}_{1} \% = {{h}_{1} ( {h}_{o} {s}_{o} + {h}_{1} {s}_{1} + {n}_{o} )}^{*} - {h}_{o}^{*} ( - {h}_{o} {s}_{1}^{*} + {h}_{1} {s}_{o}^{*} + {n}_{1} ) \\ = ( {\vert {h}_{o} \vert}^{2} + {\vert {h}_{1} \vert}^{2} ) {s}_{1} + {h}_{1} {n}_{o}^{*} + {h}_{o}^{*} {n}_{1}\end{matrix} & ( 12 )\end{matrix}$$

The estimated symbols are summed together to generate, as shown in Eq. (13) to recover the composite signal, which was meant to be sent in the first place

$$\begin{matrix}S = {\hat{s}}_{o} + {\hat{s}}_{1} \\ = ( {\vert {h}_{o} \vert}^{2} + {\vert {h}_{1} \vert}^{2} ) {s}_{o} + {h}_{o} {n}_{o}^{*} + {h}_{1}^{*} {n}_{1} + ( {\vert {h}_{o} \vert}^{2} + {\vert {h}_{1} \vert}^{2} ) {s}_{1} + \\ {h}_{1} {n}_{o}^{*} + {h}_{o}^{*} {n}_{1} \\ = ( {\vert {h}_{o} \vert}^{2} + {\vert {h}_{1} \vert}^{2} ) ( {s}_{o} + {s}_{1} ) + {h}_{o} {n}_{o}^{*} + {h}_{1}^{*} {n}_{1} + {h}_{1} {n}_{o}^{*} + {h}_{o}^{*} {n}_{1} \\ = ( {\vert {h}_{o} \vert}^{2} + {\vert {h}_{1} \vert}^{2} ) ( {s}_{o} + {s}_{1} ) + ( {h}_{o} + {h}_{1} ) {n}_{o}^{*} + ( {h}_{1}^{*} + {h}_{o}^{*} ) {n}_{1}\end{matrix} \qquad ( 13 )$$

Using Eq. (7) and Eq. (13) we get

$$\begin{matrix}S = {\hat{s}}_{o} + {\hat{s}}_{1} \\ = ( {\vert {h}_{o} \vert}^{2} + {\vert {h}_{1} \vert}^{2} ) ( \begin{matrix}{V}_{o} [ cos ( θ ( t ) ) + i sin ( θ ( t ) ) ] + \\ {V}_{o} [ - cos ( θ ( t ) ) + i sin ( θ ( t ) ) ]\end{matrix} ) + \\ ( {h}_{o} + {h}_{1} ) {n}_{o}^{*} + ( {h}_{1}^{*} + {h}_{o}^{*} ) {n}_{1} \\ = ( {\vert {h}_{o} \vert}^{2} + {\vert {h}_{1} \vert}^{2} ) ( 2 {V}_{o} sin ( θ ( t ) ) i ) + ( {h}_{o} + {h}_{1} ) {n}_{o}^{*} + ( {h}_{1}^{*} + {h}_{o}^{*} ) {n}_{1}\end{matrix} \qquad ( 14 )$$

Now further using Eq. (13) and Eq. (14) we get the following

$$\begin{matrix}S = {\hat{s}}_{0} + {\hat{s}}_{1} \\ = ( {\vert {h}_{0} \vert}^{2} + {\vert {h}_{1} \vert}^{2} ) ( 2 {V}_{0} sin ( θ ( t ) ) i ) + ( {h}_{0} + {h}_{1} ) {n}_{0}^{*} + ( {h}_{1}^{*} + {h}_{0}^{*} ) {n}_{1} \\ = ( {\vert {h}_{0} \vert}^{2} + {\vert {h}_{1} \vert}^{2} ) ( 2 {V}_{0} sin ( {sin}^{- 1} ( \frac{a ( t )}{2 {V}_{0}} ) ) i ) + \\ ( {h}_{0} + {h}_{1} ) {n}_{0}^{*} + ( {h}_{1}^{*} + {h}_{0}^{*} ) {n}_{1} \\ = {\overbrace{( {\vert {h}_{0} \vert}^{2} + {\vert {h}_{1} \vert}^{2} ) ( a ( t ) )}}^{recovered} + ( {h}_{0} + {h}_{1} ) {n}_{0}^{*} + ( {h}_{1}^{*} + {h}_{0}^{*} ) {n}_{1}\end{matrix} \qquad ( 15 )$$

### SUMMARY OF THE INVENTION

In an LINC amplifier the overall performance of LINC system relies heavily on the signal combiner placed at the outputs of the amplifier. These combiners have issues of powerless and isolation. In this paper we have presented a novel signal combining technique for LINC amplifiers by using the 2×1 Alamouti STBC. In this technique the space-time diversity of the codes is exploited to achieve the combining at the receiver. A mathematical derivation is presented for the support of the concept. This technique promises the mitigation of the isolation problem, elimination of combiner power loss and relaxation in antenna spacing requirements

### REFERENCES

1. C. Eklund, et al., “IEEE standard 802.16: a technical overview of the WirelessMAN™ air interface for broadband wireless access,” IEEE communications magazine, vol. 40, pp. 98-107, 2002.
2. E. Seidel, “Progress on “LTE Advanced”—The new 4G Standard,” White Paper, Nomor Research, 2008.
3. C. Liang, et al., “Nonlinear amplifier effects in communications systems,” IEEE Transactions on Microwave Theory and Techniques, vol. 47, pp. 1461-1466, 1999.
4. D. Cox, “Linear amplification with nonlinear components,” Communications, IEEE Transactions on [legacy, pre-1988], vol. 22, pp. 1942-1945, 1974.
5. F. Casadevall and A. Valdovinos, “Performance analysis of QAM modulations applied to the LINC transmitter,” IEEE Transactions on Vehicular Technology, vol. 42, pp. 399-406, 1993.
6. A. Choffrut, et al., “Traveling wave tube-based LINC transmitters,” IEEE Transactions on Electron Devices, vol. 50, pp. 1405-1407, 2003.
7. M. Helaoui, et al., “A new mode-multiplexing LINC architecture to boost the efficiency of WiMAX up-link transmitters,” IEEE Transactions on Microwave Theory and Techniques, vol. 55, pp. 248-253, 2007.
8. B. Stengel and W. Eisenstadt, “LINC power amplifier combiner method efficiency optimization,” IEEE Transactions on Vehicular Technology, vol. 49, pp. 229-234, 2000.
9. G. Poitau, et al., “Experimental characterization of LINC outphasing combiners' efficiency and linearity,” in Radio and Wireless Conference, 2004 IEEE, 2004, pp. 87-90.
10. M. M. Abdelaal, “LINC based amplifier architectures for power efficient wireless transmitters,” Ph.D. Thesis, Ecole Polytechnique, Montreal (Canada), 2009.
11. S. M. Alamouti, “A simple transmit diversity technique for wireless communications,” Selected Areas in Communications, IEEE Journal on, vol. 16, pp. 1451-1458, 1998.

What I claim is:

1. A method of combining signals from LINC amplifier branches using the N×1 space-time code (STC) at the receiver, obviating the need for use of RF combiner at the transmitter in LINC amplifier.

2. The method of combining signals of claim 1 wherein N=2.

3. A method of combining signals in LINC amplifier at receiver through diversity combiner.

4. A method of combining the signals in the LINC amplifier at the receiver on the baseband level.

5. A method to combine the signals in the LINC amplifier at the receiver without altering the channel characteristics of the individual branches.
